(19) United States
(12) Patent Application Publication
(10) Pub. No.: US 2004/0216939 A1
(43) Pub. Date: Nov. 4, 2004

(54) Occupant restraining system with a belt force limiting device

(76) Inventors: Carsten Lorenz, Sindelfingen (DE); Michael Meyer, Altdorf (DE); Manfred Mueller, Deizisau (DE); Harald Rudolf, Tuebingen (DE); Frank Schink, Grosselfingen (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/477,629

(22) PCT Filed: Apr. 3, 2002
(86) PCT No.: PCT/EP02/03701

(30) Foreign Application Priority Data
May 17, 2001 (DE) 101 23 921.1

(51) Int. Cl. B60R 21/32

(52) U.S. Cl. 180/268; 280/735

(57) ABSTRACT

The invention relates to an occupant restraining system in a motor vehicle, having a seatbelt and a belt force limiting device, in which the restraining force level can be changed by a control signal. According to the invention, the belt force limiting device (16) is switched by a control signal from a lower restraining force level to a higher restraining force level when a risk-determining stage (12) determines that there is a risk to the occupant in the form of a possible impact of the occupant against a vehicle interior component located in front of him.

### BACKGROUND AND SUMMARY OF THE INVENTION

This invention relates to an occupant restraining system in a motor vehicle with a belt force limiting device.

There are occupant restraining systems nowadays on most seats in motor vehicles. In the event of the vehicle having an accident, they are used to keep the injuries to the occupants as minor as possible. Use is made these days of occupant restraining systems with seat belts and “airbags”.

An airbag generally known in practice is a gas sack which can be inflated automatically in the event of an accident. When not in use, the airbag is arranged in a folded-together state in an accommodating space, for example behind a trim panel in the interior of the vehicle, laterally in the seat or in the door. At a critical driving state, the gas sack emerges from this accommodating space by being inflated. In this arrangement, the gas sack is inflated within a short period by means of a sensor-controlled gas generator, with the result that a balloon-like protective cushion is formed to protect the occupant.

In addition, seat belts have also already been used for a long time in motor vehicles to protect the occupants. Many different types of seat belts of this type are therefore also known. Thus, many vehicles are equipped, for example, with belts which are commercially available, which are arranged either at two or three fastening points in the vehicle, and which are intended to prevent the force of inertia which arises in the event of a sudden, sharp braking or impact of the vehicle against an obstacle from causing the bodies of the people in the vehicle from being displaced forward.

If a vehicle collides against an obstacle, in particular at high speed, the force of inertia causes the occupants to be hurled forward. If safety devices are not present, accidents of this type generally end with the people in the vehicle having severe and sometimes fatal injuries. If, in contrast, the vehicles are equipped, inter alia, with seat belts, the occupants do generally have prospects of surviving, but the restraining force applied by the belt is, under some circumstances, very high for the occupants.

A method for limiting the restraining force exerted on the occupant via a belt in an occupant restraining system is described, for example, in European patent application EP 0 734 922. In this case, in a restraining system having a seatbelt and inflatable restraining element, the restraining, force exerted on the occupant by the belt is limited by a force limiter to a level which can be set and which can be adapted to the height or the weight of the vehicle occupant. The force level is set here in such a manner that, in the characteristic curve depicting the force over the path of forward displacement within a section, after the traversing of which the contact between the belt webbing and inflated restraining element is anticipated, the characteristic curve has a falling tendency. The force limiter itself is designed here in such a manner that the restraining force is limited by plastic deformation of the material, and the severity of the deformation of the material can be varied as a function of parameters which are representative of the height or the weight of the occupant.

German publication DE 196 04 483 C1 describes a safety device for motor vehicles, in which a control device connected to measuring sensors is provided for the controlled influencing of the restraining characteristics of the safety device, which has a seatbelt, for the occupant in the vehicle within the bounds of the range of human endurance. The safety device is intended to be set up in respect of the best possible restraining characteristics. For this purpose, the control device is coupled to a blocking device for the belt webbing. The blocking device has a force limiting device permitting a limited extension of the belt webbing in such a manner that the force profile originating from the force limiting device and/or the extent of the permissible extension of the belt up to complete blocking of the extension of the belt is monitored, controlled and limited as a function of the occupant's body data detected by the control device, the seat position data relating to the passenger cell, and/or the data concerned with the accident conditions.

In the case of this safety device, it has proven disadvantageous that the influence of other safety restraining devices in the vehicle is not taken into consideration.

A structural implementation of a force limiter is described in German publication DE 43 31 027 C2. In the case of this self-locking seatbelt retractor having a blocking device which can be activated in a vehicle-sensitive and/or belt-webbing-sensitive manner and having a tightening device which acts on the belt-winding-up shaft and is provided with a drive device, the belt retractor being provided with a force limiting device for a limited extension of the belt webbing, the intention is to ensure that, during normal operation of the seatbelt retractor, the force limiting device is not subject to any stress. Provision is made in this respect for the force limiting device to be able to be switched on and off via a coupling connected in between, as a function of the functional states of the belt retractor and/or of the tightening device.

In this belt force limiter, other occupant restraining devices likewise do not have any effect on the force level which is exerted.

German publication DE 19604483 C1 describes a belt force limiting device which controls and limits the force profile in a force limiting process. For this purpose, the seat position and body data of an occupant and data concerned with the accident conditions are detected and evaluated. The initial force limiting level is set in accordance with the result of the evaluation, and the force level, which has a degressive profile, is readjusted by means of a measurement of the extension of the belt webbing.

German publication DE 19907395 A1, which describes a seatbelt device with a belt force limiter, is considered to be the closest prior art. The seatbelt device described therein furthermore comprises a locking device which responds if a predetermined accident severity is exceeded, and prevents the seatbelt from continuing to unwind.

It is also known from German publication DE 19731689 A1 to regulate the force level of the belt force limiter during the events of the accident as a function of the accident severity.

Furthermore, German publication DE 19517440 A1 discloses a belt system in which the belt force limiting device changes from a higher to a lower restraining force level in order to reduce the load exerted on the occupant by the belt webbing.

German publication DE 19951655 A1 describes reducing the belt force continuously during the course of the accident, occupant parameters, such as weight and position, being used as input parameters for defining the degressive profile of the belt force.

The present invention provides an occupant restraining system with a limitation of the restraining force exerted on an occupant by a belt. The system makes it possible to further reduce the load on the occupant in an accident.

The occupant restraining system according to the invention in a vehicle comprises a seatbelt with a belt force limiting device in which the restraining force level can be changed. The belt force limiting device has at least two restraining force levels, a switch being made from a lower restraining force level to a higher restraining force level if a risk-determining stage determines that there is a risk to an occupant. A risk to an occupant which has been determined means that the risk-determining stage determines, by means of the detected parameters, that, in an accident, there is a risk to an occupant due to an impact of the occupant against a vehicle interior component, for example that the probability of an impact of an occupant's head against the front soft trim of the vehicle interior, against a display or operating element, or against the steering wheel exceeds a predeterminable threshold value. In the basic state, the restraining force level is set in such a manner that the load exerted on the occupant by the belt webbing is as small as possible, with an occupant additionally being restrained by the airbag. Only when it is necessary in order to protect against an impact in the vehicle interior, for example because a particularly severe accident has occurred or the airbag has not ignited, is the occupant subjected to a higher restraining force which acts on the occupant by means of the belt webbing. The release state of an airbag is used to determine the risk to the occupant in respect of an impact against a vehicle interior component. For example, in the case of a multistage airbag, it is detected which airbag stage has been ignited. The belt force level is adapted to the accident severity and to the release state of the airbag by the restraining force level being raised if the original restraining force level in conjunction with the released airbag stage is not sufficient in order to protect the occupant against an impact in the vehicle interior.

In one refinement of the occupant protection system, the risk-determining stage detects a signal which is indicative of a deactivation of the airbag. For example, a signal for the airbag warning light or an airbag standby signal can be interrogated on a data bus. This signal is used by the risk-determining stage to determine whether there is a risk to an occupant, and if there is a risk, a switch is made to a higher restraining force level. In particular, a conclusion is then already made about a risk when a signal indicating a deactivation of an airbag is detected. One advantage of this refinement is that the detection of a signal which is indicative of the deactivation of the airbag is very simple, and the protective effect can be increased considerably by means of a simple evaluation.

In an alternative refinement, the risk-determining stage detects or determines the intensity of a crash and/or a forward displacement of an occupant and/or an occupant's weight and/or the number of ignited ignition stages of an airbag to determine a risk. The advantage of this alternative refinement is that the parameters which are used can also be used for lowering the restraining force level and/or for further adaptation of the release of occupant protection means. This permits use for multiple purposes and/or for other functions.

The forward displacement of the occupant, which is a function of time, can be calculated as a theoretical value and is produced, for example, as the difference between the actual locus curve of a vehicle and the theoretical locus curve of a free-flying body in the interior of the vehicle. Instead of a theoretical calculation, the extension of the belt webbing may also be detected and a conclusion therefore made about the forward displacement of the occupant.

In a simple example, the difference in speed between the vehicle and collision object can be viewed as the intensity of a crash or accident severity. A more reliable statement about the intensity of a crash is obtained by considering the mass and the impact location of the collision object. The accident severity can be determined from the vehicle acceleration profile which is detected.

In a further refinement, the risk-determining stage determines that there is a risk to an occupant when the intensity of a crash, a forward displacement of an occupant, and an occupant's weight are above predeterminable threshold values, and at least one stage of a multistage airbag, in particular the second airbag stage of a two-stage airbag, has not been ignited.

In another refinement of the occupant protection system, a switch is made to a higher restraining force level during the course of an accident. This switching over can be effected in particular after a switch has already been made beforehand to a lower restraining force level and/or after the belt force limiting device is already effective. For example, it is determined during an accident that the accident severity is below a predeterminable threshold and the first airbag stage has already been released. The restraining force level is then reduced in order to reduce the load exerted on the occupant by the restraining system. If, during the further course of the accident, it is determined that the accident severity is greater than the accident severity originally determined and the occupant may already be in a position which no longer permits ignition of a further airbag stage, then the restraining force level is raised to the original retaining force level or to an even higher level. This permits an early decision to be taken over the setting of the restraining force level and an early activation of the belt force limiting device, since an early decision, which gives rise to an increased risk of the wrong decision, can be corrected in the event of error and the an impact of the occupant in the vehicle interior can thereby be prevented.

Advantageous embodiments of the occupant protection system according to the invention will be described in greater detail below with reference to the drawings.

### BRIEF DESCRIPTION OF THE DRAWINGS

FIG. 1 shows a block diagram of one advantageous embodiment of an occupant protection system according to the invention, in which a deactivation of the airbag is detected.

FIG. 2 shows a block diagram of an alternative embodiment of the occupant protection system according to the invention, which permits the restraining force level to be raised during the course of the accident.

### DETAILED DESCRIPTION OF THE INVENTION

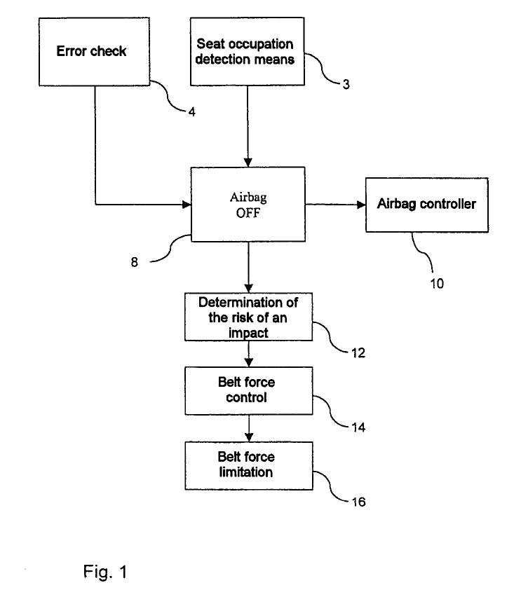

FIG. 1 shows a block diagram of one advantageous embodiment of an occupant protection system according to the invention, in which a deactivation of the airbag is detected. A seat occupation detection means 3 detects which vehicle seats are occupied and transmits this information to the airbag deactivation stage 8. An error signal is transmitted by an error checking stage 4 to the airbag deactivation stage 8 if the error checking stage 4 determines a malfunction in the occupant restraining system. The airbag deactivation stage 8 detects the signals of the seat occupation detection means 3 and of the error checking stage 4, determines from them the seats where an airbag is not to be released in an accident, and transmits this information to the airbag controller 10 and to the risk-determining stage 12 which determines the risk to an occupant of impacting against a component in the interior of the vehicle in an accident. If an airbag is deactivated, a risk is assumed as given and this fact is transmitted to the belt force controlling stage 14. In an accident, the belt force controlling stage 14 causes the restraining force level of the belt force limiting device 16 to be increased on the seats on which a risk has been determined.

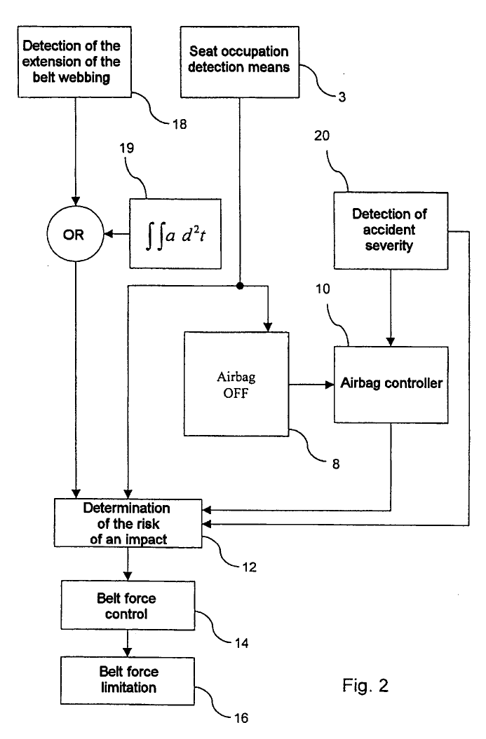

FIG. 2 shows a block diagram of another embodiment of the occupant protection system according to the invention, which permits the restraining force level to be raised during the course of the accident. As in the embodiment of FIG. 1, a seat occupation detection means 3 detects whether a vehicle seat is occupied and transmits this information to the airbag deactivation stage 8. In addition, the seat occupation detection means 3 also detects the occupant's weight and transmits the information about the weight to the risk-determining stage 12. The extension of the belt webbing is detected by a belt-webbing-extension detection stage 18 and a forward displacement of an occupant during a collision is determined. As an alternative or as a supplement to this, the forward displacement of the occupant during a collision is calculated in an occupant-forward-displacement calculation stage 19 from the deceleration of the vehicle and is transmitted to the risk-determining stage 12. The airbag deactivation stage 8 detects the signals of the seat occupation detection means 3 and determines from them the seats where an airbag is not to be released. The deactivation stage 8 transmits to the airbag controller 10 which airbags are deactivated and are therefore not released in a collision. An accident-severity detection device 20 detects signals which permit a determination of the accident severity/intensity of the crash, for example the vehicle speed directly before the collision or acceleration signals from one or more acceleration sensors in the vehicle. The accident-severity determining device 20 determines the accident severity from the signals which have been detected, and transmits this fact to the risk-determining stage 12 and the airbag controller 10. The airbag controller 10 transmits information about the activated airbags, in particular about the ignition stage with which the airbags are ignited, to the risk-determining stage 12. The risk-determining stage 12 determines a risk to an occupant by checking whether the accident severity/intensity of the crash is above a predeterminable threshold value and whether the occupant's weight is greater than a predeterminable threshold value and whether the forward displacement of the occupant is greater than a predeterminable threshold value and, in the case of a multistage airbag, whether only the first stage or at least not all of the stages have been ignited. If these four conditions are fulfilled, there is a risk and a corresponding signal is transmitted to the belt force controlling stage 14. The belt force controlling stage 14 causes the restraining force level of the belt force limiting device 16 to be increased on the seats at risk. Preferably, not all of the belt force limiting devices are activated, but rather only those devices which belong to seats where the seatbelt is being worn. In particular, the increase in the restraining force level takes place after an early assessment of an,accident as not serious and an associated reduction in the belt force level turns out during the continuation of the accident to be erroneous, since the acceleration profile which has been detected indicates a severe accident.

In an alternative of the embodiment of FIG. 2, it is also possible for just one or some of the four parameters of accident severity, forward displacement of the occupant, occupant's weight and airbag activation stage to be detected and for corresponding test conditions to be checked by the risk-determining stage 12.

1-8. (Canceled)

9. An occupant restraining system in a motor vehicle, comprising:
a seatbelt, and
a belt force limiting device in which a restraining force level can be changed by a control signal,
wherein the belt force limiting device is activated by the control signal in such a manner that a higher restraining force level is set when a risk-determining stage detects a signal which is indicative of deactivation of the airbag.

10. The occupant restraining system as claimed in claim 9, wherein a signal of an airbag warning light is detected as the signal indicative of deactivation of the airbag.

11. The occupant restraining system as claimed in claim 9, wherein the belt force limiting device is switched by a control signal from a lower restraining force level to a higher restraining force level.

12. The occupant restraining system as claimed in claim 10, wherein the belt force limiting device is switched by a control signal from a lower restraining force level to a higher restraining force level.

13. An occupant restraining system in a motor vehicle, comprising:
a seatbelt, and
a belt force limiting device in which a restraining force level can be changed by a control signal,
wherein the belt force limiting device is activated by a control signal in such a manner that a higher restraining force level is set when at least one of an intensity of a crash, a forward displacement of an occupant, and an occupant's weight is above a predeterminable threshold value and at least one stage of a multistage airbag has not been ignited.

14. The occupant restraining system as claimed in claim 13, wherein the belt force limiting device is activated by a control signal in such a manner that a higher restraining force level is set when the intensity of the crash, the forward displacement of the occupant, and the occupant's weight are above predeterminable threshold values and at least one stage of the multistage airbag has not been ignited.

15. The occupant restraining system as claimed in claim 13, wherein the multistage airbag is a two-stage airbag.

16. The occupant restraining system as claimed in claim 14, wherein the multistage airbag is a two-stage airbag.

17. The occupant restraining system as claimed in claim 13, wherein a restraining force level of the belt force limiting device is increased by a control signal from a lower restraining force level to a higher restraining force level.

18. The occupant restraining system as claimed in claim 14, wherein a restraining force level of the belt force limiting device is increased by a control signal from a lower restraining force level to a higher restraining force level.

19. The occupant restraining system as claimed in claim 15, wherein a restraining force level of the belt force limiting device is increased by a control signal from a lower restraining force level to a higher restraining force level.

20. The occupant restraining system as claimed in claim 16, wherein a restraining force level of the belt force limiting device is increased by a control signal from a lower restraining force level to a higher restraining force level.

21. The occupant restraining system as claimed in claim 17, wherein the restraining force level is increased after the restraining force level has been lowered beforehand during an accident.

22. The occupant restraining system as claimed in claim 18, wherein the restraining force level is increased after the restraining force level has been lowered beforehand during an accident.

23. The occupant restraining system as claimed in claim 19, wherein the restraining force level is increased after the restraining force level has been lowered beforehand during an accident.

24. The occupant restraining system as claimed in claim 20, wherein the restraining force level is increased after the restraining force level has been lowered beforehand during an accident.
